(19) United States
(12) Patent Application Publication
(10) Pub. No.: US 2012/0033755 A1
(43) Pub. Date: Feb. 9, 2012

(54) Transmit Mode Switching for MIMO Base Stations

(75) Inventors: Markus Ringström, Stockholm (SE); Bo Göransson, Sollentuna (SE); Fredrik Ovesjö, Alvsjo (SE)

(73) Assignee: TELEFONAKTIEBOLAGET LM ERICSSON (PUBL), Stockholm (SE)

(21) Appl. No.: 13/264,612

(22) PCT Filed: Apr. 22, 2009
(86) PCT No.: PCT/SE2009/050413

§ 371 Date: Oct. 14, 2011

Related U.S. Application Data
(60) Provisional application No. 61/170,167, filed on Apr. 17, 2009.

(51) Int. Cl. H04B 7/02

(52) U.S. Cl. 375/267

(57) ABSTRACT

In a transmitter using at least two transmitting antennas a STTD transmitter is used in combination with a common pre-coding transmitter for power amplifying power balancing. A selector can be provided for selecting data/channels transmitted using STTD and common pre-coding such that for one channel type, STTD or common pre-coding is used whereas the combination of both STTD and common pre-coding is used for a different data/channel type. By selectively using both STTD and common pre-coding for power amplifier power balancing, an improved power balancing is achieved. At the same time, the STTD gain is obtained in the relevant cases but the STTD loss in other cases is avoided.

### TECHNICAL FIELD

The present invention relates to a transmitter and a method for using the transmitter. In particular the present invention relates to transmission from an antenna comprising at least two transmitting antennas.

### BACKGROUND

The evolution of radio interface standards has focused on providing increased data rates. In Third Generation Partnership Project (3GPP) Release 7 Multiple Input Multiple Output (MIMO) was introduced, which theoretically doubles the downlink data rate through the use of multiple data stream transmission, when using two transmitting antennas.

Though certain User Equipment (UE) categories will support MIMO transmission, the network still has to support legacy UE categories not having MIMO capability. Support for legacy UEs can be provided by transmitting all system vital information and traffic channels aimed for a legacy UE on a single antenna. However, if there are separate Power Amplifiers (PAs) for the two antennas, which is typically the case, the utilization of the PAs will be suboptimal. This problem of sub-optimal use of the power amplifiers can be reduced by adding Butler matrices in the radio base station NodeB, to distribute the load equally over two power amplifiers. This solution is however associated with the drawback that it requires additional hardware. In addition it will introduce a power loss in a non-ideal implementation.

Another solution is to transmit all channels not using MIMO from the two antennas through the use of Space-Time Transmit Diversity (STTD), which is an open loop transmit diversity scheme standardized in 3GPP Release 99, and hence shall be supported by all UEs on the market. However, even though STTD transmission alleviates the power amplifier power balancing problem and may be beneficial for common channels, there is less benefit for dedicated channels and in particular the High-Speed Downlink Shared Channel (HS-DSCH). In fact STTD may actually harm the performance in certain cases, especially on the HS-DSCH which is a shared and scheduled resource. Typically STTD is designed to combat fast fading, but in the case of a scheduled channel, as HS-DSCH, STTD may be harmful since the gain from scheduling stems from the fast fading. In FIG. 1, a block diagram for a STTD encoder for Quadrature Phase Shift Keying (QPSK) is shown. Furthermore, equalization is more difficult in the UE since the signal and the intra-cell interference now is transmitted from two antennas instead of one.

Hence, there is a need to improve performance for an antenna transmitter using multiple transmit antennas when transmitting to a User Equipment not configured for MIMO.

### SUMMARY

It is an object of the present invention to eliminate or reduce the problems as described above.

This object and others are obtained by the method and device as set out in the appended claims.

Thus, in accordance with the present invention STTD is used in combination with a common pre-coding for power amplifier power balancing when transmitting from at least two antennas to a User equipment possibly not configured for MIMO.

In accordance with one embodiment a method of transmitting signals in a radio base station comprising a transmitter using at least two transmitting antennas is provided. Data is transmitted to a user equipment over an air interface connection. When transmitting the data the transmitter selects which data or channels to transmit using a Space-Time Transmit Diversity, STTD, transmission method and or a common pre-coding transmission method. In particular a common pre-coding transmission method or a common pre-coding transmission method in combination with Space-Time Transmit Diversity, STTD is selected. The transmitter then transmits the data according to the selection.

The common pre-coding can be variable over time, but is in accordance with one embodiment common for all data applicable to the common pre-coding method. In accordance with one embodiment the pre-coding is common for all physical channels such as common channels, dedicated channels and shared channels. In accordance with one embodiment the common pre-coding is independent of the radio channel.

In accordance with one embodiment a selector is provided for selecting channels transmitted using STTD and common pre-coding such that for one channel type, STTD or common pre-coding is used whereas the combination of both STTD and common pre-coding is used for a different channel type. In accordance with one embodiment some channels are coded using a combination of STTD and a common pre-coder, whereas other channels are coded using only a common pre-coder.

In accordance with one embodiment, common channels are transmitted using STTD and a common pre-coder, whereas shared channels are transmitted using common pre-coding only. There may also be other selection criteria than channel type for selecting power amplifier power balancing method.

By selectively using both the STTD method and common pre-coding method for power amplifier power balancing, improved power balancing is achieved. At the same time, the STTD gain is obtained in the relevant cases but the STTD loss in other cases is avoided.

The invention extends both to a transmission method for transmitting data to a non MIMO user equipment from a transmitter using at least two transmitting antennas and to a transmitter adapted to transmit data according to the transmission method. By selectively using both the STTD method and common pre-coding method for power amplifier power balancing, power balancing is achieved. At the same time, the STTD gain is obtained in the relevant cases but the STTD loss in other cases is avoided.

### BRIEF DESCRIPTION OF THE DRAWINGS

The present invention will now be described in more detail by way of non-limiting examples and with reference to the accompanying drawings, in which:

FIG. 1 is a block diagram illustrating a STTD encoder for Quadrature Phase Shift Keying,

FIG. 2 is a block diagram illustrating a transmitter using common pre-coding,

FIG. 3 is a view of a cellular radio system

FIG. 4 is a block diagram of a transmitter using two transmit antennas, and

FIG. 5 is a flow chart illustrating some procedural steps performed when transmitting data to a user equipment.

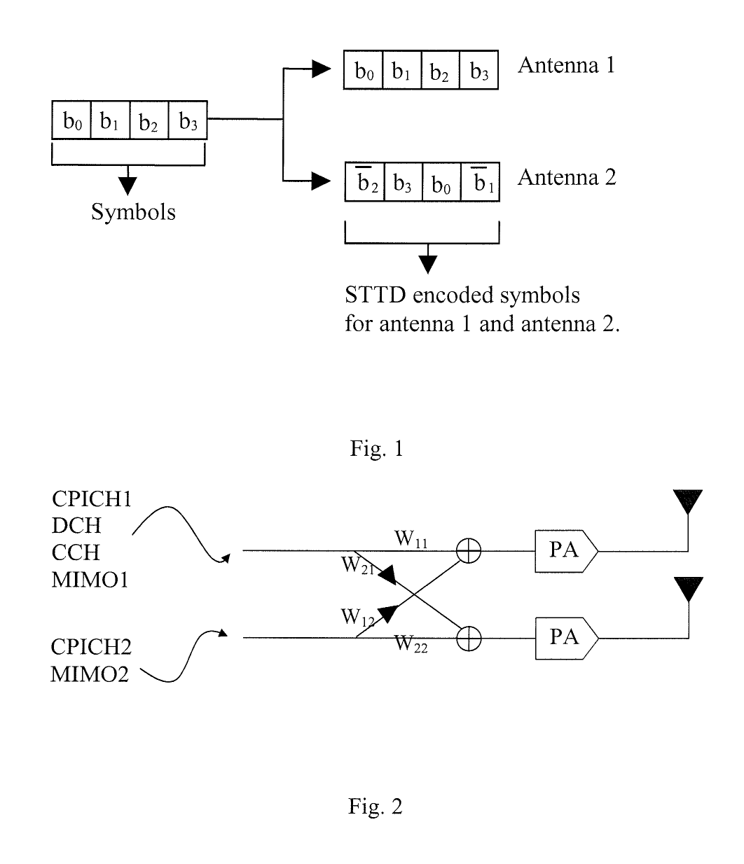

### DETAILED DESCRIPTION

To overcome the problems in the power amplifiers and the balancing thereof, a common pre-coder (transformation) at the transmitter which transforms the actual antenna domain into a virtual antenna domain can be provided. In this virtual antenna domain all power amplifiers in a transmitter using multiple transmit antennas will be used even in the case when a non-MIMO channel is transmitted without transmitter diversity.

The common pre-coder is in addition to the channel dependent pre-coder which exists for a MIMO transmission in both High Speed Downlink Packet Access (HSDPA) and Long Term Evolution (LTE). Such a common transformation can, in principle, be applied to any antenna installation.

A common pre-coder transmitter for a transmitter using multiple transmit antennas can be implemented in a number of different ways. In accordance with one exemplary embodiment common pre-coding can be obtained using a transmitter comprising two transmit antennas as depicted in FIG. 2. In case a transmitter in accordance with FIG. 2 is used, full power balancing between the power amplifiers is achieved. But the drawback is that no gain from STTD is achieved.

The common pre-coding can be implemented in any suitable manner, preferably resulting in an orthogonal, or close to orthogonal, pre-coding. The pre-coding is defined by the pre-coding matrix, depicted as [w11 w12; w21 w22] in FIG. 2 for the two antenna case. The pre-coding matrix is of size N×N for the case of N transmit antennas. The pre-coding is considered orthogonal if the columns of the pre-coding matrix are linearly independent. One example of an orthogonal pre-coding matrix is [w11 w12; w21 w22]=[1 1; −1 1]. In accordance with one embodiment the weights of the common pre-coder can be set to vary over time.

In accordance with the present invention a transmitter enabling STTD in parallel with common pre-coding for PA power balancing is provided.

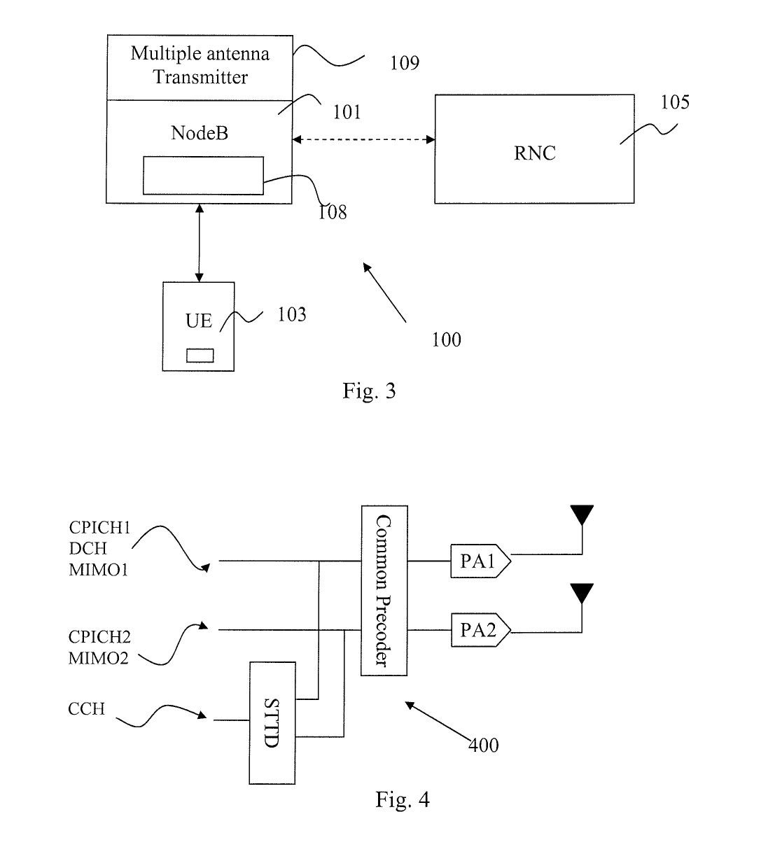

In FIG. 3, a view of a cellular radio system 100 is depicted. The system comprises a number of radio base stations here denoted Node B 101. The NodeBs 101 can in turn be connected to a central node of the cellular radio system such as a Radio Network Controller (RNC). The base stations 101 are further connectable to User Equipments 103 of the radio system 100 over a radio interface, thereby providing access to the cellular radio system for a User Equipment located within an area covered by the cellular radio system. The NodeB is provided with a transmitter 109 having two transmit antennas enabling MIMO transmission over the air interface. In order to provide good performance for UEs not configured for MIMO, the transmitter 109 is adapted to transmit using STTD in parallel with common pre-coding for PA power balancing. In addition the NodeB can be provided with a selector 108. The selector 108 can be configured to switching between STTD and common pre-coding such that for one channel type, STTD or common pre-coding is used whereas the combination of both STTD and common pre-coding is used for a different channel type. In accordance with one embodiment, the selector can select transmitter differently for common channels, dedicated channels and shared channels. There may also be other selection criteria than channel type for selecting power amplifier power balancing method. In accordance with one embodiment a central node is given the task to set the transmission method for a given connection.

In order to achieve good power amplifying power balancing, a node in the network of a cellular radio system can hereby be adapted to decide whether to apply common pre-coding only or STTD and common pre-coding for a given connection.

In FIG. 4 a block diagram of a transmitter 400 with two transmit antennas is depicted. In the configuration of the transmitter depicted in FIG. 4 pilot signals transmitted on a Common Pilot Channel (CPICH), MIMO encoded signals and dedicated channels (DCH) are selected to use a common pre-coder in order to utilize the total power resource while common channels (CCH) are also STTD encoded.

In one embodiment, common channels are transmitted using STTD and common pre-coding and shared channels, such as HS-DSCH without MIMO, are transmitted using common pre-coding only. Since the HS-DSCH applies the same transmission mode as the associated dedicated channel (A-DCH), these channels are transmitted using common pre-coding only in this case. In one embodiment, the A-DCHs may be replaced by Fractional Dedicated Physical Channel (F-DPCH)s, if applicable. The remaining dedicated channels can be transmitted either with STTD and common pre-coding or common pre-coding only.

In one embodiment, the selection of power amplifying power balancing method can be made dynamically. The selection can for example be based on the time dispersion of the radio channel. In one embodiment STTD is used in a lightly dispersive radio channel. The transmission method can then be configured to use STTD when the time dispersion is below some pre-set value, and otherwise not used. In one embodiment a dynamic use of STTD is used for dedicated channels, but not A-DCH or F-DPCH. The selection of when to use STTD and for which channels can also be made based on other criteria such as Signal to Interference Ratio (SIR) or another measure reflecting the characteristics of the radio channel. The selection can also be made as a combination of type of channel and a dynamic selection. For example different threshold levels can be applied for different channels.

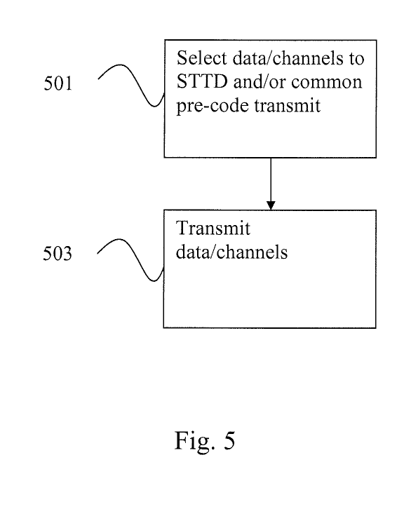

In FIG. 5, a flow chart illustrating some procedural steps performed when transmitting data to a user equipment not supporting MIMO using a transmitter having at least two transmit antennas, which can be used for enabling MIMO transmission are shown. First in a step 501 data to be transmitted over the connection to transmit using a Space-Time Transmit Diversity, STTD, transmission method and or a common pre-coding transmission method are selected. For example some channels can be selected to be transmitted using STTD and a common pre-coding and other channels can be selected to be transmitted using only pre-coding as described above. Next, in a step 503, data are transmitted in accordance with the selection made in step 501.

In accordance with the transmitter and transmission method as described herein the power amplifier power balancing problem is solved partly or completely by applying a channel independent pre-coder, which forms a virtual antenna, and for some data/channels combining this with STTD over the formed virtual antenna elements to achieve the STTD gain where applicable, but avoiding STTD where it is harmful.

By selectively using both the STTD method and common pre-coding method for power amplifier power balancing, power balancing is achieved. At the same time, the STTD gain is obtained in the relevant cases but the STTD loss in other cases is avoided.

1-14. (canceled)

15. A method of transmitting signals from a radio base station comprising a transmitter using at least two transmitting antennas, wherein data is transmitted to a user equipment over an air interface connection, the method comprising:
selecting which data to transmit over the connection using at least one of a Space-Time Transmit Diversity (STTD) transmission method and a common pre-coding transmission method based on a type of downlink radio channel used for transmission; and
transmitting the data according to the selection.

16. The method according to claim 15, wherein transmitting the data comprises transmitting the data on common downlink channels using the STTD transmission method.

17. The method according to claim 15, wherein selecting which data to be transmitted comprises dynamically selecting which data to be transmitted.

18. The method according to claim 17, wherein dynamically selecting which data to be transmitted comprises dynamically selecting which data to be transmitted based on a measure reflecting characteristics of the downlink radio channel used for transmitting the data.

19. The method according to claim 18, wherein the measure comprises a Signal-to Interference Ratio.

20. The method according to claim 18, wherein the measure comprises a delay spread of the downlink radio channel.

21. The method according to claim 15, wherein transmitting the data comprises transmitting some data using the common pre-coding transmission method only, and transmitting other data using a combination of the common pre-coding and STTD transmission methods.

22. A transmitter comprising:
at least two transmitting antennas for transmitting signals from a radio base station to a user equipment over an air interface connection;
a Space-Time Transmit Diversity (STTD) transmitter;
a common pre-coding transmitter; and
a selector configured to select which data to transmit over the connection using at least one of the (STTD) transmitter and the common pre-coding transmitter based on a type of downlink radio channel used for transmission.

23. The transmitter according to claim 22, wherein the transmitter is configured to transmit common downlink channels using the STTD transmitter.

24. The transmitter according to claim 22, wherein the selector is further configured to dynamically select at least one of the STTD transmitter and the common pre-coding transmitter.

25. The transmitter according to claim 24, wherein the selector is configured to dynamically select at least one of the STTD transmitter and the common pre-coding transmitter based on a measure reflecting characteristics of the downlink radio channel used for transmitting the data.

26. The transmitter according to claim 25, wherein the measure comprises a Signal-to Interference Ratio.

27. The transmitter according to claim 25, wherein the measure comprises a delay spread of the downlink radio channel.

28. The transmitter according to claim 22, wherein the transmitter is configured to transmit some data using the common pre-coding transmitter only, and to transmit other data using a combination of the common pre-coding transmitter and the STTD transmitter.
